(19) United States
(12) Patent Application Publication
(10) Pub. No.: US 2008/0270708 A1
(43) Pub. Date: Oct. 30, 2008

(54) System and Method for Achieving Cache Coherency Within Multiprocessor Computer System

(76) Inventors: Craig Warner, Richardson, TX (US); Bryan Hornung, Richardson, TX (US); Chris Michael Brueggen, Richardson, TX (US); Ryan L. Akkerman, Richardson, TX (US); Michael K. Dugan, Richardson, TX (US); Gary Gostin, Richardson, TX (US); Harvey Ray, Ft. Collins, CO (US); Dan Robinson, Richardson, TX (US); Christopher Greer, Richardson, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/741,858

(22) Filed: Apr. 30, 2007

(51) Int. Cl. G06F 12/08

(52) U.S. Cl. 711/146; 711/E12.041

(57) ABSTRACT

A system and method are disclosed for achieving cache coherency in a multiprocessor computer system having a plurality of sockets with processing devices and memory controllers and a plurality of memory blocks. In at least some embodiments, the system includes a plurality of node controllers capable of being respectively coupled to the respective sockets of the multiprocessor computer, a plurality of caching devices respectively coupled to the respective node controllers, and a fabric coupling the respective node controllers, by which cache line request signals can be communicated between the respective node controllers. Cache coherency is achieved notwithstanding the cache line request signals communicated between the respective node controllers due at least in part to communications between the node controllers and the respective caching devices to which the node controllers are coupled. In at least some embodiments, the caching devices track remote cache line ownership for processor and/or input/output hub caches.

### CROSS-REFERENCE TO RELATED APPLICATIONS

### STATEMENT REGARDING FEDERALLY SPONSORED RESEARCH OR DEVELOPMENT

### FIELD OF THE INVENTION

The present invention relates to computer systems, and more particularly relates to systems and methods for achieving cache coherency within multiprocessor computer systems.

### BACKGROUND OF THE INVENTION

To achieve greater processing power, many computer systems now are multiprocessor computer systems that can be scaled to large sizes by adding greater and greater numbers of processors. Such multiprocessor computer systems also typically are designed such that the memory of the computer systems is also allocated to the various processors, which control access to the respective memory blocks with which the processors are respectively associated.

To allow all of the processors of the multiprocessor computer systems to access all of the different memory blocks that are allocated to the various processors and at the same time prevent the occurrence of circumstances in which the accessing of a given memory location by one processor conflicts with the accessing of that memory location by another processor, such computer systems typically employ cache coherency protocols by which the status of the various memory locations is tracked and conflicts are avoided.

Many conventional multiprocessor computer systems employ processors that interact with the memory allocated to those processors by way of a separate memory control device. In at least some such systems, “in main memory” directory-based cache coherency protocols are employed in order to scale the systems. Yet the efficacy of such cache coherency protocols are not easily implemented on computer systems in which the memory controllers are fully integrated (e.g., on a single socket or chip) with the processors controlling those memory controllers, since in such systems the memory controllers can employ protocols that are limited in their scalability.

For at least these reasons, therefore, it would be advantageous if in at least some embodiments an improved multiprocessor computer system and/or method of operating such a computer system could be developed that allowed such a computer system to be easily scaled from having smaller to larger numbers of processing devices, notwithstanding usage within the computer system of processing devices having integrated memory controllers incapable of employing cache coherency protocols suitable for such large-scale multiprocessor computer systems.

### SUMMARY OF THE INVENTION

In at least some embodiments, the present invention relates to a system for achieving cache coherency in a multiprocessor computer having a plurality of sockets respectively associated with a plurality of respective memory blocks, the sockets having processing devices and memory controllers. The system includes a plurality of node controllers capable of being respectively coupled to the respective sockets of the multiprocessor computer, a plurality of caching devices respectively coupled to the respective node controllers, and a fabric coupling the respective node controllers, by which cache line request signals can be communicated between the respective node controllers, whereby cache coherency is achieved notwithstanding the cache line request signals communicated between the respective node controllers due at least in part to communications between the node controllers and the respective caching devices to which the node controllers are coupled.

Additionally, the present invention in at least some embodiments relates to a caching device. The caching device includes a matrix including a plurality of filter tag entries each identifiable as a respective intersection of a respective way and a respective index, and an index hash block by which one of the indexes is selected in response to an incoming signal. The caching device also includes a comparison block by which one of the filter tag entries associated with the selected one index is further selected,

Further, the present invention in at least some embodiments relates to a method of operating a multiprocessor computer in a cache coherent manner. The method includes communicating a request signal concerning a first cache line from a first component via a fabric to a second component that includes a node controller, and sending a further signal from the node controller to a caching device coupled to the node controller to obtain first information concerning a state of the cache line. The method additionally includes, if the caching device determines that the first information concerning the state of the cache line is unavailable at the caching device, then facilitating further communications via the node controller and the fabric between the first component and a first processing device to which the node controller is coupled so as to allow accessing by the first component of a first memory device controlled by the first processing device. Also (or alternatively) the method additionally includes, if the caching device determines that the first information concerning the state of the cache line is available at the caching device, then providing a further snoop signal from the node controller to a current owner of the cache line.

### BRIEF DESCRIPTION OF THE DRAWINGS

FIG. 1 is a schematic diagram showing exemplary components of a computer system having multiple cells that are in communication with one another, in accordance with one embodiment of the present invention;

FIG. 2 is an additional schematic diagram showing in more detail certain of the components of FIG. 1 as well as exemplary signal flows among and within those components, in accordance with one embodiment of the present invention; and

FIG. 3 is a schematic diagram showing an exemplary configuration of a filter tag cache of FIGS. 1 and 2 in accordance with one embodiment of the present invention.

### DETAILED DESCRIPTION OF THE PREFERRED EMBODIMENT

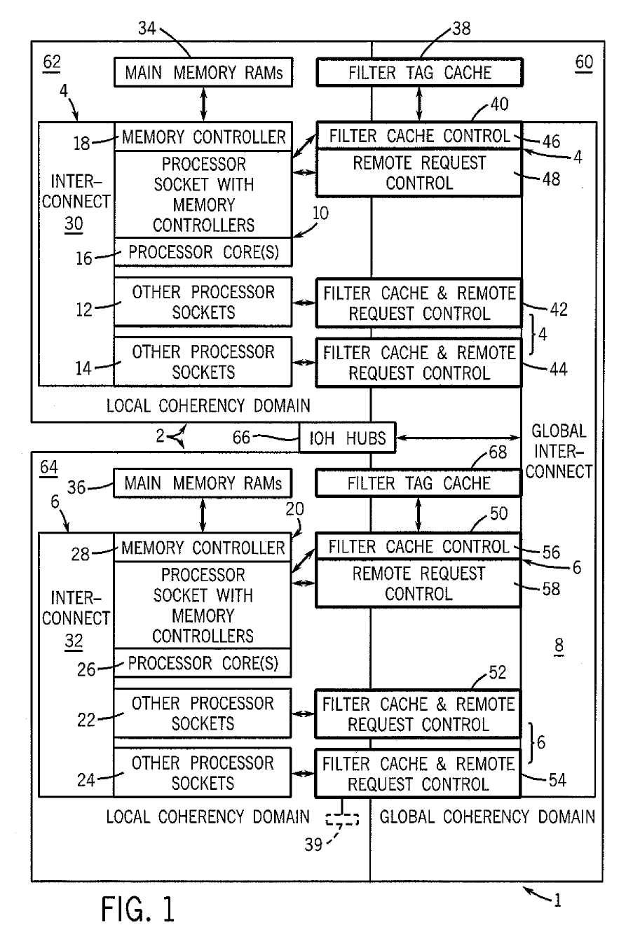

Referring to FIG. 1, components of an exemplary multiprocessor computer system 1 in accordance with at least one embodiment of the present invention are shown in a simplified schematic form. As shown, the computer system 1 includes a partition 2 having two field replaceable units (FRUs) or “cells”, namely, a first cell 4, a second cell 6, and a fabric 8 to facilitate communication between those two cells. The two cells 4, 6 can be understood to be formed on two separate printed circuit boards that can be plugged into, and connected by, a backplane (on which is formed or to which is coupled the fabric 8). Although the computer system 1 of the present embodiment includes only the single partition 2 having the first and second cells 4 and 6, it is nevertheless intended to be representative of a wide variety of computer systems having arbitrary numbers of partitions with arbitrary numbers of cells and/or circuit boards. For example, in other embodiments, multiple partitions, each having a single cell or possibly more than two cells, can be present and coupled with one another by way of the fabric 8. Also for example, the second cell 6 can alternatively be representative of multiple cells.

In at least some embodiments, the computer system 1 is a s×1000 super scalable processor chipset available from the Hewlett-Packard Company of Palo Alto, Calif., on which are deployed hard partitions (also known as “nPars”) on one (or more) of which exist the cells 4, 6. Hard partitions allow the resources of a single server to be divided among many enterprise workloads and to provide different operating environments (e.g., HP-UX, Linux, Microsoft Windows Server 2003, OpenVMS) simultaneously. Such hard partitions also allow computer resources to be dynamically reallocated. Although the computer system 1 can be the super scalable processor chipset mentioned above, it need not be such a chipset and instead in other embodiments can also take a variety of other forms.

Each of the cells 4, 6 is capable of supporting a wide variety of hardware and software components. More particularly as shown, each of the cells 4, 6 in the present embodiment includes multiple sockets on which are implemented multiple processors as well as memory controllers. For example, the first cell 4 includes first, second and third sockets 10, 12 and 14, respectively. The first socket 10 in particular includes processors 16 as well as a memory controller 18. Although not shown in detail, the other sockets 12, 14 can also be understood to include both processors and one or more memory controllers. Similarly, the second cell 6 includes first, second and third sockets 20, 22 and 24, respectively, where the first socket 20 include processors 26 as well as a memory controller 28 and the other sockets also include processors and one or more memory controllers. Further as shown, the respective sockets of each of the cells 4, 6 are coupled to one another by a respective interconnection device. That is, the sockets 10, 12 and 14 of the first cell 4 are coupled to and capable of communications with one another by way of an interconnection device 30, while the socket s 20, 22 and 24 of the second cell 6 are coupled to and capable of communications with one another by way of an interconnection device 32.

The respective processors of the sockets 10, 12, 14, 20, 22, 24, which can be referred to alternatively as cores or central processing units (CPUs), typically are formed on chips that are coupled by way of electrical connectors to the respective circuit boards corresponding to the respective cells 4, 6. Although the processors (e.g., the processors 16, 26) are intended to be representative of a wide variety of processing devices, in the present embodiment, the processors are Itanium processing units as are available from the Intel Corporation of Santa Clara, Calif.. In other embodiments, one or more of the processors can take other forms including, for example, Xeon and Celeron also from the Intel Corporation. In alternate embodiments, one or more of the processors can be another type of processor other than those mentioned above. The various processors on a given cell (or on a given socket), and/or on different cells need not be the same but rather can differ from one another in terms of their types, models, or functional characteristics. Also, although the present embodiment shows the cells 4, 6 each as having multiple processors, it is also possible for a given cell to have only a single processor.

Further as shown, the respective memory controllers 18 and 28 of the respective sockets 10 and 20 are in communication with respective memory blocks 34 and 36. Although only the memory blocks 34 and 36 that are respectively in communication with the sockets 10 and 20 are shown in FIG. 1, it should be understood that additional memory blocks (not shown) are respectively in communication with the other sockets 12, 14, 22, and 24. That is, typically there are respective memory blocks that are allocated to each of the respective processor sockets, albeit in some embodiments it is possible that certain sockets will not have any memory blocks or that two or more sockets will all have access to, and share, a given block of memory.

The memory blocks 34, 36 can take a variety of different forms depending upon the embodiment. For example, in one embodiment of the present invention, the memory blocks 34, 36 can each include a main memory formed from conventional random access memory (RAM) devices such as dynamic random access memory (DRAM) devices. In other embodiments, the memory blocks 34, 36 can be divided into multiple memory segments organized as dual in-line memory modules (DIMMs). In alternate embodiments, the memory blocks 34, 36 can be formed from static random access memory (SRAM) devices such as cache memory, either as a single level cache memory or as a multilevel cache memory having a cache hierarchy. In further embodiments, the memory blocks 34, 36 can be formed from other types of memory devices, such as memory provided on floppy disk drives, tapes and hard disk drives or other storage devices that can be coupled to the computer system 1 of FIG, 1 either directly or indirectly (e.g., by way of a wired or wireless network), or alternatively can include any combination of one or more of the above-mentioned types of memory devices, and/or other devices as well.

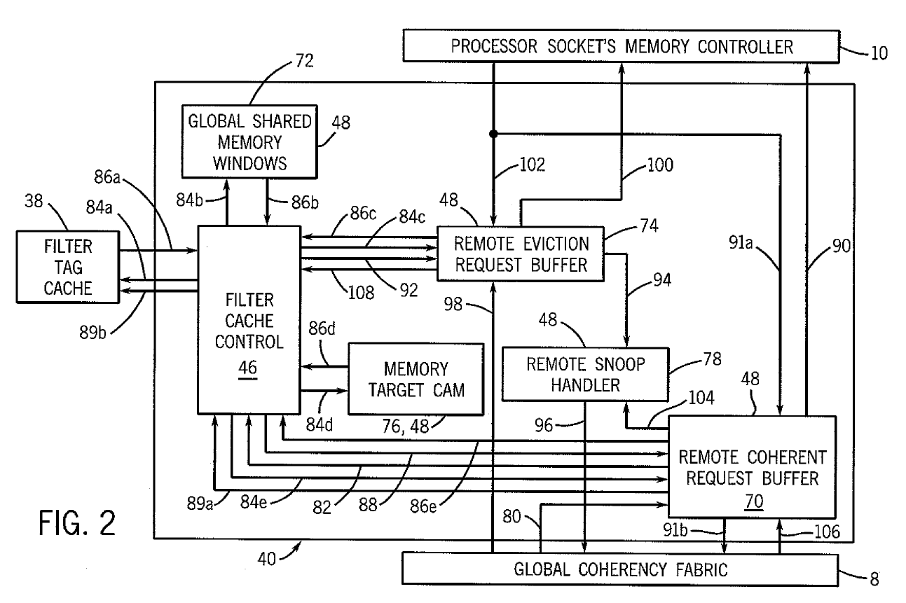

In the present embodiment, each of the cells 4, 6 also includes a plurality of agents or node controllers that are respectively coupled to and in communication with the respective sockets of the respective cells. More particularly as shown, the first cell 4 includes first, second and third node controllers 40, 42 and 44, respectively, that are coupled to and in communication with the first second and third sockets 10, 12 and 14, respectively. Also, the second cell includes first, second and third node controllers 50, 52 and 54, respectively, that are coupled to and in communication with the first, second and third sockets 20, 22 and 24, respectively. Additionally, as will be described further in relation to FIG. 2, each of the node controllers 40-44 and 50-54 in the present embodiment includes certain internal components that can generally be classified as filter cache control blocks and remote request control blocks. For example, the first node controller 40 of the first cell 4 includes a filter cache control block 46 and a remote request control block 48, while the first node controller 50 of the second cell 4 includes a filter cache control block 56 and a remote request control block 58.

The node controllers 40-44 and 50-54, and particularly the remote request control blocks (e.g., the blocks 48 and 58) of those node controllers serve as intermediaries between the fabric 8 and the remaining portions of the cells 4, 6, particularly the sockets 10-14 and 20-24. Further, the filter cache control blocks of the respective cells 4, 6 allow for communication between the respective node controllers 40-44 and 50-54 and respective filter tag caches 38, 68 (which can also be referred to as “RTAGs”) of the first and second cells. The filter tag caches 38, 68, which in at least some embodiments can be formed as on-chip static random access memory (SRAM) devices, can also be considered as forming parts of the respective cells 4, 6. Although only the filter tag caches 38, 68 are shown in FIG. 1 to be respectively coupled to the node controllers 40 and 50, respectively, it should be understood that each of the node controllers 40-44 and 50-54 has its own filter tag cache with which it is coupled (that is, each of the cells 4, 6 actually includes three filter tag caches even though only one such filter tag cache is shown in FIG. 1). Also, while the filter tag caches 38, 68 are shown to be distinct from (albeit coupled to) the node controllers 40, 50 in the present embodiment, in alternate embodiments the filter tag caches could be incorporated into the respective node controllers as parts of the node controllers.

With respect to the fabric 8, it is a hardware device that can be formed as part of (or connected to) the backplane of the computer system 1, and can take the form of one or more crossbar devices or similar chips. The cells 4, 6 are connected to the fabric 8 during configuration when those cells are installed on the partition 2 within the computer system 1. The fabric 8 serves as a global intermediary for communications among the various resources of the computer system 1 during operation of the computer system, including resources associated with different partitions (not shown) of the computer system. In order for signals provided to the fabric 8 to be properly communicated via the fabric to their intended destinations, in the present embodiment, the signals must take on virtualized fabric (or global) addresses that differ from the physical addresses employed by the signals when outside of the fabric. Additionally as shown, the fabric 8 is also coupled to one or more input/output hubs (IOHs) 66 that represent one or more input/output (I/O) devices. By virtue of the fabric 8 these I/O devices also can attempt to access memory blocks such as the memory blocks 34, 36 that are associated with the various cells 4, 6.

In the present exemplary embodiment of FIG. 1, the computer system 1 is a multiprocessor computer system formed by way of socket-chips that each have not only one or more processors on the respective chips but also have one or more memory controllers on the respective chips, albeit the memory devices (e.g., the memory blocks 34, 36) are not part of the respective chips. The particular configuration and architecture of the computer system 1 shown in FIG. 1, with the node controllers 40-44, 50-54 and the fabric 8, is designed to facilitate the operation of such a multiprocessor computer system. The node controllers and fabric in particular provide an exemplary “home agent” filter cache architecture in which multiple local cache coherency domains are bridged together using a global coherency domain so that a scalable, shared memory multiprocessor system can be built using microprocessors with “on-chip” memory controllers. Systems adopting this architecture can scale to larger numbers of processors than the number supported natively by the processor socket and its own memory controller as in conventional systems.

More particularly in the example of FIG. 1, a first local coherency domain 62 encompassing the first cell 4 (including the sockets 10-16, interconnection device 30, node controllers 40-44, and filter tag cache 38) is bridged in relation to a second local coherency domain 64 encompassing the second cell 6 (including the sockets 20-26, interconnection device 32, node controllers 50-54, and filter tag cache 68) by way of the node controllers and the fabric 8. Although the present example shows only the two local coherency domains 62 and 64, it should be further understood that the present architecture is generally expandable to any arbitrary number of local coherency domains, cells, sockets, processors, etc. To support protocol bridging, all of main memory of the computer system (e.g., the memory blocks 34 and 36) is divided among the filter tag caches of the system.

The manner in which cache coherency among these coherency domains is established and maintained is explained below in detail with respect to FIG. 2. Generally speaking, each filter tag cache is assigned responsibility for the memory controlled by the processor socket to which it is connected, and can be considered the “home agent” filter tag cache for that memory. More particularly, the home agent filter tag cache for any given memory portion is responsible for tracking remote cache line ownership and storing cache line ownership information for all remotely-owned cache lines pertaining to its associated region of memory. For example, the filter tag cache 38 is responsible for the tracking remote cache line ownership in relation to the memory block 34, while the filter tag cache 68 is responsible for tracking remote cache line ownership in relation to the memory block 36. This ownership information allows the node controllers 40-44, 50-54 to handle remote requests received off of the fabric 8 (e.g., a request received by the node controller 40 from the cell 6), as well as to properly direct snoops arising from the processor sockets with which the node controllers are respectively associated in accordance with their respective local cache coherency protocols (e.g., a snoop received at the node controller 40 from the socket 10 and intended for the cell 6).

Further for example, in response to receiving remote read requests off of the fabric, the node controllers know whether to forward the read requests to the memory controllers of the sockets with which the node controllers are associated, or alternatively to issue snoops to remote owners. Additionally, in response to receiving remote write requests off of the fabric, the node controllers can sanity check write-back and exclusive eviction requests to make sure writes are coming from an authorized remote owner. Also, for snoops issued from a local coherency domain's cache coherency protocol, the respective node controller associated with that local coherency domain can determine which remote owner should be snooped even though the local coherency domain's cache coherency protocol is only capable of specifying that the cache line of interest is owned by an indeterminate remote owner. If a cache line is owned only by a processor in the local coherency domain with which a node controller is affiliated, the node controller will not track ownership of the cache line and does not need to be consulted for requests. This enables the lowest possible cache miss latency for cache coherency requests that stay entirely in the local coherency domain.

Turning then to FIG. 2, portions of the computer system 2 are shown in more detail along with exemplary signals that are communicated within the computer system in response to an exemplary remote cache line request. More particularly, the node controller 40 of the cell 4 is shown to be in communication with each of its associated filter tag cache 38, its associated socket 40 and the fabric 8. Further, the node controller 40 is shown to include, in addition to the filter cache control block 46, several internal components that together form the remote request control block 48 of FIG. 1, namely, a remote coherent request buffer block 70, a global shared memory windows block 72, a remote eviction request buffer block 74, a memory target content addressable memory (CAM) block 76, and a remote snoop handler block 78. The blocks 70-78 are hardware components typically formed in an agent application specific integrated circuit (ASIC) chip that perform specific functions as described in further detail below.

The internal components 70-78, 46 of the node controller 40 interact with one another and in relation to the filter tag cache 38, the socket 10 and the fabric 8 in response to remote cache line requests received from other sockets, particularly sockets associated with cells other than the cell 4 on which is located the socket 10. One such remote cache line request can be, for example, a read request received from one of the processors of the socket 20 of the cell 6 via the fabric 8. Such a remote cache line request can be handled by the node controller 40 as follows. Upon receipt of the remote cache line request at the fabric 8, a corresponding signal 80 is in turn communicated to the remote coherent request buffer block 70 of the node controller 40 (and, more particularly, of the remote request control block 48). As indicated above, the signal received from the fabric 8 includes a virtualized address rather than an actual, physical address, so as to allow transmission of the signal over the fabric. Upon receiving the signal 80, the remote coherent request buffer block 70 precipitates a tag lookup for the transaction by sending a further signal 82 to the filter cache control block 46.

Subsequently, the filter cache control block 46 sends in a substantially simultaneous manner five signals 84a, 84b, 84c, 84d and 84e, respectively, to five different locations. More particularly, the filter cache control block 46 sends the signal 84a to the filter tag cache 38, which results in a read being performed at that cache (e.g., an SRAM read) in order to obtain the tag lookup requested by the remote coherent request buffer block 70. Further, the filter cache control block 46 also sends the signals 84c and 84e, respectively, to the remote eviction request buffer 74 and back to the remote coherent request buffer 70, in response to which an address cache coherency conflict check is performed. This conflict check in particular is performed to determine whether another request is currently being handled that pertains to the same cache line location as the presently-received remote cache line request. More particularly, the present architecture implements a multi-stage pipeline to perform conflict detection so only one request is allowed to alter the coherency state for a given cache line at a time. This is accomplished by CAMMing other outstanding remote requests, outstanding locally initiated snoop requests, and outstanding filter cache eviction requests

Additionally, the signal 84d is sent by the filter cache control block 46 to the memory target CAM block 76 so as to gather information regarding attributes of the memory block/segment being accessed as well as, in some cases, to determine whether a requested memory type is not available. The memory target CAM block 76 also (along with possibly additional assistance from another address conversion block, which is not shown) serves to convert the virtualized fabric address into a physical address appropriate for contacting the requested cache line. As for the signal 84b, that signal is sent by the filter cache control block 46 to the global shared memory windows block 72 so as to check in this sequence for coherent request(s) made from outside the partition 2 or local coherency domain (e.g., to perform a remote partition access check, where remote partition accesses can be either granted or denied). The global shared memory windows block 72 also serves to keep track of which memory segments have been opened up or made available to multiple partitions, and keeps track of which partitions have access to the various memory segments.

Once the filter tag cache 38, global shared memory windows block 72, remote eviction request buffer block 74, memory target CAM block 76 and remote coherent request buffer block 70 have acted in response to the respective signals 84a, 84b, 84c, 84d and 84e, respectively, those components send responsive signals back to the filter cache control block 46 as represented by further signals 86a, 86b, 86c, 86d, and 86e, respectively. The information provided by the respective signals 86a-86e can depend upon what is determined by the filter tag cache 38 and the blocks 70-76.

Assuming that the desired filter tag is not present at the filter tag cache 38 (e.g., the cache line is not currently owned and so there is a cache miss), and assuming that no conflicts are present (as determined by the remote eviction request buffer block 74 and the remote coherent request buffer block 70), then the filter cache control block 46 in turn sends a further signal 88 back to the remote coherent request buffer block 70 indicating the filter tag cache directory state and a physical address for the remote cache line request. The remote coherent request buffer 70 in turn sends a signal 90 to the memory controller 18 corresponding to the node controller 40, in response to which the appropriate accessing (in this case, reading) of the appropriate segment of the memory block 34 is able to occur using the physical address information. The accessed information is subsequently provided back to remote coherent request buffer block 70 as indicated by a signal 91a, and then further forwarded by that block to the processor/socket of the cell 6 that initiated the remote cache line request as indicated by a signal 91b. Additionally, the remote coherent request buffer block 70 also sends a further signal 89a to the filter cache control block 46 notifying it of the new owner of the requested cache line, and the filter cache control block in turn sends a signal 89b to the filter tag cache 38 updating that cache with the ownership information.

The above description in particular envisions operation by the filter tag cache 38 that is “inclusive”. That is to say, if there is a cache miss, then this is guaranteed to indicate that no processor (or other entity) within the computer system 2 has remote ownership of the requested cache line. However, in alternate embodiments, it also possible that one or more of the filter tag caches such as the filter tag cache 38 are “non-inclusive”. In such embodiments, even if there is a cache miss with respect to a given filter tag cache, it is still possible that some remote entity has ownership of the requested cache line (for example, where there is the possibility of shared ownership of cache lines, in which case the filter tag cache is non-inclusive for shared lines). Consequently, when a cache miss occurs, in such embodiments a broadcast snoop is then executed with respect to the entire computer system 2 (e.g., everything connected to the fabric 8), such that all entities are notified that they must give up ownership of the requested cache line to the extent that they have ownership of that cache line. This broadcast snoop is to be contrasted with a targeted snoop as discussed further below.

Notwithstanding the above discussion regarding circumstances in which there is a “cache miss”, in other circumstances further actions must be taken before access to the requested memory block segment can be granted in response to the remote cache line request. More particularly, in contrast to the above-described circumstance, sometimes upon receiving the signal 84a the filter tag cache 38 recognizes that the requested cache line is already owned by another entity, for example, one of the processors of the socket 22 of the cell 6. In that case, the filter tag cache 38 provides the ownership information in the signal 86a, and this information then is returned to the remote coherent request buffer block 70 in the signal 88. When this occurs, the remote coherent request buffer block 70 in turn sends a snoop request signal 104 to the remote snoop handler 78, which then sends a snoop signal 96 via the fabric 8 to the current owner of the requested cache line (again, for example, a processor of the socket 22).

In response to this action, the current owner invalidates its corresponding cache line (assuming it is not already invalid) and further sends a further signal 106 back to the remote coherent request buffer block 70 via the fabric 8 indicating that the current owner has given up its ownership of the requested cache line, and communicating the current information stored by the current owner in relation to that cache line. After this occurs, the remote coherent request buffer block 70 sends the signal 89a to the filter cache control block 46, which in turn sends the signal 89b to the filter tag cache 38, and thereby updates the filter tag cache with the updated ownership information concerning the requested cache line. Also at this time, the remote coherent request buffer block 70 sends the signal 91b via the fabric 8, to the remote entity that requested the cache line (e.g., a processor on the socket 20), the data received from the original owner of the cache line, which constitutes the most recently-updated data for the cache line. However, no communication occurs at this time between the remote coherent request buffer block 70 and the memory controller 10 in order to obtain the information stored at the cache line in the memory controller (e.g., neither of the signals 90 or 91a occurs), since that information is stale information relative to the information that was provided from the original owner of the cache line by way of the signal 106.

In still other operational circumstances, it is possible that upon the receiving of a remote cache line request at the remote coherent request buffer block 70, and subsequent communication of the signals 82 and 84a to the filter cache control block 46 and the filter tag cache 38, respectively, it will be determined by the filter tag cache that it does not have sufficient room to store new cache line ownership information. That is, it may be the case that the filter tag cache 38 is sufficiently full of cache line entries that it does not have room to store new information corresponding to a reassignment of the requested cache line in response to the remote cache line request. If this is the case, a previously active way in the filter tag cache 38 can be used as a replacement. To achieve this, the signal 86a returned from the filter tag cache 38 indicates that the cache is currently full and additionally indicates an appropriate cache line that should be replaced. The filter cache control block 46 upon receiving the signal 86a from the filter tag cache 38 in turn sends an eviction request signal 92 to the remote eviction request buffer block 74 in addition to providing the signal 88 to the remote coherent request buffer block 70. In response to the signal 92, the remote eviction request buffer block 74 sends a further eviction snoop request signal 94 to the remote snoop handler block 78, which then issues an appropriate (targeted) snoop signal 96 to the fabric 8.

The snoop signal 96 by way of the fabric 8 eventually reaches the owner of the cache line indicated by the filter tag cache 38 (in the signal 86a) as being the cache line that should be replaced. For example, the owner can be one of the processors associated with the socket 24 of the cell 6. Upon receiving the snoop signal 96, the owner invalidates its cache line entry, and subsequently an eviction snoop response signal 98 is returned by that owner via the fabric 8 to the remote eviction request buffer block 74. Once this occurs, the remote eviction request buffer block 74 in turn sends a signal 100 to the socket 10 with which the node controller 40 is associated, thus causing that socket to give up the ownership line. When that is accomplished, a further signal 102 is provided back from the socket 10 to the remote eviction request buffer 74, which in turn provides a signal 108 to the filter cache control block 46 indicating that the filter tag cache can be updated with the new cache line ownership information in place of the evicted cache line information. The filter cache control block 46 then sends a signal to the filter tag cache 38 (e.g., the signal 89b) to update that cache. It should be further noted that the remote coherent request buffer block 70 is unaware of the above-described eviction process.

Although the above discussion presumes that cache line requests to a node controller come from remote devices (e.g., from different cells and/or different local coherency domains), it should further be noted that in some operational circumstances cache line requests can also come from one or more of the processors of the socket with which the node controller is associated (e.g., within the same local coherency domain). For example, it is possible that the node controller 40 can receive a cache line request from one of the processors of the socket 10. Such a request can be represented by the signal 91a of FIG. 2, which then triggers operational behavior by the remote coherent request buffer block 70 similar to that which occurs in response to the receipt of remote cache line requests as discussed above.

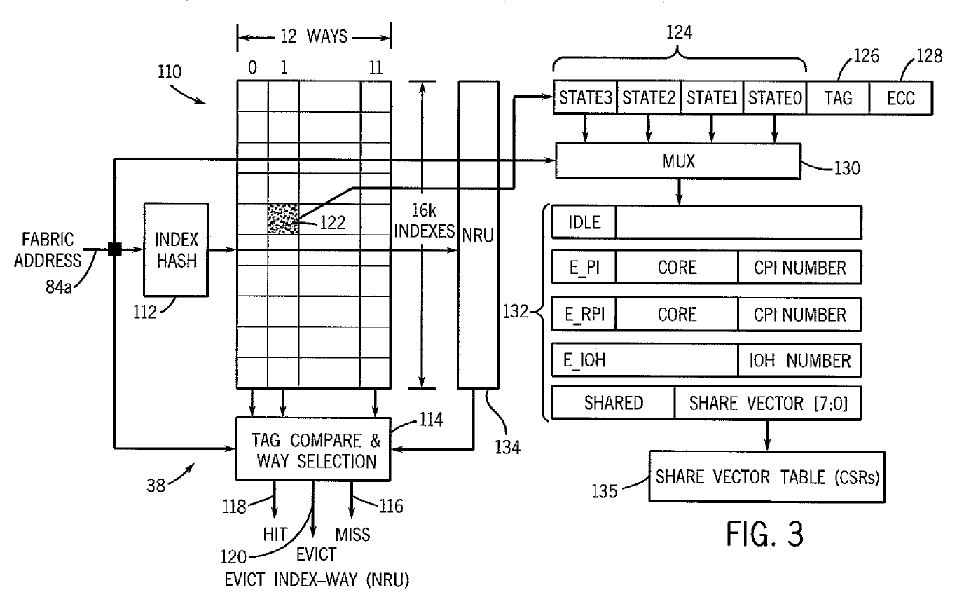

The configuration and operation of the filter tag cache 38 can take a variety of forms depending upon the embodiment. In the present embodiment, the filter tag cache 38 takes a form illustrated by FIG. 3. As shown, the filter tag cache 38 in particular includes a matrix 110 having twelve ways and 16K indexes. Incoming signals (e.g., the signal 84a of FIG. 2) to the filter tag cache 38 that arrive in response to remote cache line requests include both fabric address information and tag information. Upon such a signal (again, for example, the signal 84a) reaching the filter tag cache, the signal is first processed by an index hash table 112 so as to select one of the 16K indexes. Then the tag information is further compared against each of the 12 ways of the filter tag cache entries corresponding to the selected index, at a tag compare and way selection block 114. As discussed above, in any given circumstance it is possible that a requested cache line will not find a corresponding entry in the filter tag cache 38 such that there is a cache miss 116, or that a requested cache line will match a corresponding entry within the filter tag cache so as to result in a hit 118, or that upon the occurrence of a cache line request an eviction will need to occur 120, it being understood that the signal 86a from the filter tag cache can indicate any of these three conditions.

To the extent that the hit 118 occurs, an entry within the filter tag cache 38 such as a tag entry 122 is identified as corresponding to the requested cache line. As shown, in the present embodiment, each entry such as the entry 122 tracks remote ownership of four, consecutive cache lines in main memory. The tag entry 122 includes four state fields 124, a tag field 126, and an error correcting code field 128. The state fields 124 track the cache coherency state for each of the four cache lines, and have the encoding shown in Table 1 below. The tag field 126 records the physical address bits that are not part of the cache index or cache line offset, so a filter cache hit can be determined, Although each tag entry 122 includes four state fields, in response to any given remote cache line request such as that provided by the signal 84a, a single one of the state fields 124 is selected by way of a multiplexer 130, the operation of which is governed based upon the signal 84a. The selected state can at any given time be one of five states 132 as shown in FIG. 2 and also shown in Table 1.

TABLE 1

| Filter Cache | |
|---|---|
| Tag State | Description |
| Idle | The cache line is not remotely cached. |
| E_P | Exclusive ownership given to a remote coherency domain |
| E_RP | Exclusive ownership given to a remote coherency domain |
| | and the processor which has the line belongs to a different |
| | partition than the partition as the home |
| E_IOH | Exclusive ownership given to an IOH which belongs to the |
| | same partition as the home |
| Shared | Shared by more that one processor core in the same |
| | partition as the home. |

More particularly with respect to the available states, the idle state is indicative that the cache line is not currently owned. In contrast, when the state field is E_P or E_RP, the remote domain and the core in the remote domain are stored. This allows the filter cache control block 46 to issue a snoop directly to the processor which has read/write access of the line (e.g., by way of the signal 96 of FIG. 2). The E_RP state allows the filter cache controller to disable high performance C2C optimizations for snooping line out of remote coherency domains that belong to different partitions, thereby simplifying the snoop error handling cases. As for the E_IOH state, when the state field is IOH, the IOH number is stored in the tags. Finally, when the state field is shared, a share vector is also stored in the state field. The mapping of the share vector to a set of remote caches is controlled via a set of Control Status Registers (CSRs) forming a share vector table 135 (which keeps track of who has a read-only copy of the line).

A variety of procedures can be followed by the field tag cache 38 in selecting which of its tag entries/cache lines should be evicted when (as discussed above) it is necessary for one of the tag entries/cache lines to be evicted in order to make room for new cache line ownership information. In the present embodiment, in such circumstances, a not recently used (NRU) block 134 is consulted by the filter tag cache 38 to determine that one (or more) of the tag entries/cache lines with respect to which a remote cache line request has not occurred for the longest period of time. The NRU block 134 in the present embodiments is formed using single-ported SRAM. So that the NRU block 134 can keep track of which tag entries/cache lines have not been requested, the remote request control block 48 issues notification requests for low level to higher level cache line transitions, and for exclusive to invalid cache state transitions in remote caches. When a modified or exclusive line is moved from a smaller, lower latency cache to a larger, higher latency cache or to an invalid cache state transition, the remote request control block 48 then issues a notification request to the filter cache control block 48. The filter cache control block 48 in turn updates the bits of the NRU block 134 for the lines that have transitioned, so as to write those lines as being invalid. These lines are favored if a new request must evict a non-invalid cache line out of the filter tag cache 38.

Due to the use of the NRU block 134 in this manner, in the present embodiment different types of cache line requests are classified in two pools (e.g., an “A” pool and a “B” pool). The A pool requests are requests in which updating of the NRU block 134 is required, while the B pool requests are requests in which no updating of the NRU block is needed. Since in the present embodiment the NRU block 134 is formed from single-ported SRAM, the A pool requests involving the NRU block can only be issued every other clock cycle, while the B pool requests not involving the NRU block can be issued every cycle (consecutive cycles). The restriction upon the A pool requests in particular frees up SRAM access cycles for NRU write operation, and also results in a situation in which a given read request issued to the filter cache control block 46 in any given cycle N does not have to perform conflict checking against read requests issued to the pipeline in a previous cycle N-1. Notwithstanding the above description, it should be further noted that if multi-ported SRAM is utilized for the NRU block 134, the restriction upon the A pool requests is no longer needed. Further, although the present embodiment envisions the use of the NRU block 134 in determining which tag entries/cache lines are to be evicted, in alternate embodiments, instead of utilizing an NRU block, the determination as to which tag entry/cache line should be evicted is made based upon another algorithm (e.g., first-in, first-out) or randomly.

In another embodiment operation of the filter tag cache 38 and NRU 134 depends upon the operation of one or more additional memory caches, and which include an exemplary memory cache 39 shown in FIG. 1 to be coupled to the node controller 54 associated with the socket 24. In such an embodiment each memory cache such as the memory cache 39 is a SRAM-implemented cache that can be implemented in conjunction with (or even as part of) the respective filter tag cache (e.g., the filter tag caches 38, 68) that is associated with the given socket. In some embodiments these memory caches can be level 4 (L4), level 3 (L3) or other types of caches. The memory caches in particular can serve a significant intermediate role in facilitating the operation of the sockets (processors) with which they are associated in terms of their interactions with remote home agent filter tag caches associated with other sockets, in terms of influencing how those home agent filter tag caches assign ownership to their associated memory locations, and particularly in terms of how evictions from the NRUs of those home agent filter tag caches are performed.

This role of the memory caches can be illustrated by considering the operation of the memory cache 39 in relation to the filter tag cache 38 with respect to a memory location in the memory block 34, with respect to which the filter tag cache 38 is the home agent filter tag cache. For example, suppose that a processor within the socket 24 associated with the node controller 54 has ownership of a given memory location in the memory block 34. At some point in time, that processor may decide unilaterally to “give up” ownership of that memory location. In the absence of a memory cache, the processor could directly notify the home agent filter tag cache for that memory location (namely, the filter tag cache 38) such that, in response, the filter tag cache no longer listed that processor of the socket 24 as the owner of the memory location. However, given the presence of the memory cache 39, the processor instead notifies the memory cache that it is giving up ownership of the memory location.

When this occurs, the memory cache 39 in response, rather than notifying the filter tag cache 38 of the change in ownership, instead tentatively continues to store a copy of the memory location such that the information remains accessible to the processor of the socket 24 if the processor should need that information. At the same time, however, the memory cache 39 also provides a “hint” to the NRU of the filter tag cache 38 making it appear that the memory location (cache line) has not been recently used. As a result, at such later time when it becomes necessary for the filter tag cache 38 to evict one of its entries as discussed above, the entry associated with the memory location stored by the memory cache 39 is evicted first (or sooner) than other entries. Upon the eviction notice being sent out, the memory cache 39 relinquishes control of the memory location (rather than the processor of the socket 24 doing so). By operating in this manner, the socket 24 by way of the memory cache 39 effectively retains low-latency access to the information stored in the memory location for a longer period of time than would otherwise be possible, and yet this does not limit others' access to that memory location.

In view of the above discussion, it should be evident that at least some embodiments of the presently-described home agent filter cache architecture has one or more of the following features, characteristics and advantages. First, in at least some embodiments the architecture enables the overall computer system 1 to be scalable to larger numbers of processors/sockets (e.g., up to 64 sockets or possibly even more sockets) and IOHs, particularly as are employed in multi-processor systems built with processor sockets with on-chip memory controllers. Such scaling can be achieved by bridging together multiple cache coherency domains by recording remote cache line ownership in an inclusive filter tag cache. Also, in at least some embodiments, the architecture allows for local requests by processors (e.g., within the local coherency domain) to be performed directly via the on-chip memory controllers associated with those processors without the accessing of any external devices, thereby reducing the best case cache miss latency and improving system performance.

Further, in at least some embodiments the architecture records remote core information in the filter cache tags. Consequently, when remote coherency domains need to be snooped, only the remote core that has exclusive ownership needs to be snooped to recall exclusive ownership, thereby reducing latency and increasing system performance. Additionally, in at least some embodiments the architecture records partition information in the filter tag cache so that cache coherency between partitions can utilize a different (and more fault tolerant) cache coherency protocol than the protocol used for maintaining coherency between processors in the same partition. Further, remote accesses that are hits in the filter tag cache achieve better latency than in conventional systems, since the old owner can be determined after a filter cache access rather than a DRAM access (this once again reduces cache miss latency). Also, in at least some embodiments the present architecture performs conflict checking using the filter cache control block (which also can be referred to as a filter cache tag pipeline) so the tags can be realized in a single ported memory structure which takes several cycles to access.

Further, in at least some embodiments, the architecture performs an address translation between a local and a global address to allow more flexibility with interleaving. Additionally, in at least some embodiments, the architecture performs access checks to allow remote partitions to only access authorized addresses. Further, in at least some embodiments, the architecture uses a cache tag format that groups consecutive cache lines into bundles, so as to amortize the cost of the cache tag field across multiple cache lines, thereby reducing the size of the filter tag cache. Additionally, in at least some embodiments, the architecture utilizes remote cache exclusive to invalid notification requests to remove lines from the filter tag cache, to reduce frequency of back invalidates caused by filter cache replacements, and to thereby increasing system performance. Finally, in at least some embodiments, the architecture utilizes a remote cache lower level to high level cache transfer requests to update the filter cache's NRU block bits to favor replacement of lines that reside in the highest level cache.

It is specifically intended that the present invention not be limited to the embodiments and illustrations contained herein, but include modified forms of those embodiments including portions of the embodiments and combinations of elements of different embodiments as come within the scope of the following claims.

We claim:

1. A system for achieving cache coherency in a multiprocessor computer having a plurality of sockets respectively associated with a plurality of respective memory blocks, the sockets having processing devices and memory controllers, the system comprising:
a plurality of node controllers capable of being respectively coupled to the respective sockets of the multiprocessor computer;
a plurality of caching devices respectively coupled to the respective node controllers; and
a fabric coupling the respective node controllers, by which cache line request signals can be communicated between the respective node controllers,
whereby cache coherency is achieved notwithstanding the cache line request signals communicated between the respective node controllers due at least in part to communications between the node controllers and the respective caching devices to which the node controllers are coupled.

2. The system of claim 1, wherein each of the node controllers includes a respective filter cache control block and a respective remote request control block.

3. The system of claim 2, wherein each of the node controllers includes a respective remote coherent request buffer block that is in communication with the respective filter cache control block of the respective node controller.

4. The system of claim 3, wherein each of the node controllers includes a respective eviction request buffer block and a respective remote snoop handler block that are each in communication with the respective filter cache control block of the respective node controller.

5. The system of claim 3, wherein each of the node controllers includes a respective memory target CAM block and a respective global shared memory windows block that are each in communication with the respective filter cache control block of the respective node controller.

6. The system of claim 1, wherein a first of the node controllers is associated with a first local coherency domain, a second of the node controllers is associated with a second local coherency domain, and the fabric at least in part forms a third domain that is distinct from the first and second local coherency domains.

7. The system of claim 1 wherein, upon a first of the cache line request signals arriving at the first node controller from the second node controller via the fabric, the first node controller communicates with a first of the caching devices to which the first node controller is coupled to obtain information regarding a first cache line specified by the first cache line request signal.

8. The system of claim 7, wherein the first caching device is an inclusive cache, and wherein when the first caching device determines that the information regarding the first cache line is not available at the first caching device, the first caching device provides a corresponding signal to the node controller indicating that the information is not available, and in response the node controller operates to facilitate a further communication between the second node controller and the respective memory block associated with a first socket to which the first node controller is coupled,

9. The system of claim 8, wherein the first node controller additionally provides a further signal to the first caching device causing the first caching device to store additional information indicating a new status of the first cache line.

10. The system of claim 7, wherein the first caching device is a non-inclusive cache, and wherein when the first caching device determines that the information regarding the first cache line is not available at the first caching device, the first caching device provides a corresponding signal to the node controller indicating that the information is not available, and in response the node controller causes a broadcast snoop to be provided to a plurality of remote devices.

11. The system of claim 10, wherein the first cache line is a shared cache line,

12. The system of claim 7, wherein the first caching device determines that the information regarding the first cache line is available at the first caching device, the first caching device provides a corresponding signal to the node controller indicative of the information, and in response the node controller operates to cause a snoop signal to be provided toward another device that is a current owner of the first cache line, the snoop signal resulting in the current owner giving up ownership of the first cache line.

13. The system of claim 7, wherein the first caching device determines that insufficient space exists within the first caching device to store additional information relating to the first cache line, the first caching device provides a corresponding signal to the node controller indicative of an additional cache line with respect to which an invalidation should occur, and in response the node controller operates to cause a snoop signal to be provided toward another device that is a current owner of the additional cache line, the snoop signal resulting in the current owner giving up ownership of the first cache line.

14. The system of claim 7, wherein the snoop signal is sent to a memory cache.

15. The system of claim 7, wherein the node controller converts a fabric address of first cache line request signal into a physical address of a memory location, and wherein the caching devices respectively are either (i) distinct from the respective node controllers, or (ii) incorporated as parts of the respective node controllers.

16. The multiprocessor computer comprising the system of claim 1, wherein the multiprocessor computer includes the plurality of sockets, the plurality of memory blocks, and the processing devices and memory controllers, wherein the memory controllers are integrated on chips along with the processing devices.

17. The system of claim 1, wherein at least one of the node controllers includes a component that at least one of (i) serves to keep track of which of a plurality of memory segments have been opened up or made available to a plurality of partitions, and (ii) serves to keep track of which of the plurality of partitions have access to the respective memory segments.

18. A caching device comprising:
a matrix including a plurality of filter tag entries each identifiable as a respective intersection of a respective way and a respective index;
an index hash block by which one of the indexes is selected in response to an incoming signal; and
a comparison block by which one of the filter tag entries associated with the selected one index is further selected.

19. The caching device of claim 18, further comprising means for determining that at least one of the entries has not recently been selected.

20. The caching device of claim 19, wherein each of the filter tag entries includes state information corresponding to a plurality of cache lines.

21. A system for achieving cache coherency in a multiprocessor computer, the system comprising the caching device of claim 18 and further comprising:
a first node controller in communication with each of the caching device;
a socket of a first local coherency domain with which the caching device is associated, the socket being in communication with a first memory block; and
a fabric by which the first node controller is in communication with additional local coherency domains.

22. A method of operating a multiprocessor computer in a cache coherent manner, the method comprising:
communicating a request signal concerning a first cache line from a first component via a fabric to a second component that includes a node controller;
sending a further signal from the node controller to a caching device coupled to the node controller to obtain first information concerning a state of the cache line;
if the caching device determines that the first information concerning the state of the cache line is unavailable at the caching device, then facilitating further communications via the node controller and the fabric between the first component and a first processing device to which the node controller is coupled so as to allow accessing by the first component of a first memory device controlled by the first processing device; and
if the caching device determines that the first information concerning the state of the cache line is available at the caching device, then providing a further snoop signal from the node controller to a current owner of the cache line.

23. The method of claim 22, further comprising:
if the caching device determines that insufficient space exists within the caching device to store additional cache line state information, then identifying at the caching device a first cache entry that can be evicted from the caching device to make room for the additional cache line state information.

24. The method of claim 23, wherein the identifying of the first cache entry is performed at least in part based upon a relative usage of the first cache entry in relation to other cache entries within the caching device, and wherein the first processing device is a first socket including a first processor.
